(19) United States
(12) Patent Application Publication
(10) Pub. No.: US 2005/0195390 A1
(43) Pub. Date: Sep. 8, 2005

(54) Method of testing open services gateway initiative service platform and test tool using the method

(75) Inventors: Sung-won Jeon, Seoul (KR); Gi-dae Yeo, Seoul (KR); Young-suk Jang, Uijeongbu-si (KR); Sook-hee Sung, Seoul (KR); Hyun-dong Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/063,548

(22) Filed: Feb. 24, 2005

(30) Foreign Application Priority Data
Feb. 25, 2004 (KR) 10-2004-0012746

(51) Int. Cl. G01N 21/00

(52) U.S. Cl. 356/237.2

(57) ABSTRACT

A method of effectively testing whether a service bundle operates by changing the configuration and function of bundles included in a test tool for an OSGi service platform and a test tool using the method are provided. The OSGi service platform test tool includes a framework in which test cases are installed, an adaptor enabling the framework to function in a test execution environment, a director bundle providing a UI of a test tool, services that manage the test, and OSGi services, and an agent bundle relaying message movement with the test case bundle to a framework of a target host.

### CROSS-REFERENCE TO RELATED APPLICATION

This application claims priority from Korean Patent Application No. 10-2004-0012746 filed on Feb. 25, 2004 in the Korean Intellectual Property Office, the disclosure of which is incorporated herein by reference in its entirety.

### BACKGROUND OF THE INVENTION

1. Field of the Invention

The present invention relates to a method of testing an Open Services Gateway Initiative (OSGi) service platform and a test tool using the method, and more particularly, to a method of effectively testing whether or not a service bundle is operating by changing the configuration and function of bundles included in a test tool for an OSGi service platform and a test tool using the method.

2. Description of the Related Art

FIG. 1 illustrates the entire structure of a test tool for an OSGi service platform provided by a conventional OSGi.org framework.

The test tool for an OSGi service platform shown in FIG. 1 comprises an osgi-refimpl (reference implement) bundle 200 placed in a target host 10 (host to be tested), a target bundle 202, a director bundle 204 placed in a test manager host 30, and a support bundle 206. Here, the osgi-refimpl (reference implement) bundle 200, the target bundle 202, the director bundle 204, and the support bundle 206 comprise a plurality of bundles as shown in FIGS. 2A through 2D.

However, a test tool provided by the OSGi.org framework has a complicated structure in which the osgi-refimpl bundle 200 placed in the target host 10 is installed separately from the target bundle 202. In addition, in order to add an OSGi service bundle to the osgi-refimpl bundle 200, a test currently in progress should be stopped, the osgi-refimpl bundle 200 should be decompressed, replaced with a new OSGi service bundle, and made into a Java Archive (JAR) file, and then, testing should be performed. Thus, this procedure is complicated.

The test manager host 30 has a complicated structure in which the support bundle 206 is installed separately from the director bundle 204. In addition, installation from an OSGi frame work to a test case is automatically performed using a file ‘target.bat’. Thus, in order to add test case bundles, a test bundle in which all the test case bundles are united, should be decompressed, information about the test bundle should be modified, and the modified bundle information should be made into a ‘JAR’ file. Thus, an additional test case cannot be added at an arbitrary time, and the test case bundles cannot be independently performed without unification.

Furthermore, in the prior art, when a problem occurs in a test tool graphical user interface (GUI), a test currently in progress should be forcibly terminated, so as to analyze the cause of the problem. Furthermore, since a test log is stored in a file having a byte streaming format, when a test is not in progress, the stored test log cannot be identified using a general editor program.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

The present invention provides a method by which bundles of an OSGi test tool are united with one another, thereby simplifying a structure of the test tool and enabling easy change of a test case or an OSGi service bundle to be tested.

The present invention also provides a method by which, when an error occurs in a test procedure, a test log can be easily analyzed after analyzing the cause of the error and performing the test.

According to an aspect of the present invention, there is provided an OSGi service platform test tool, the OSGi service platform test tool comprising a framework in which test cases are installed; an adaptor enabling the framework as a framework in a test execution environment; a director bundle providing a user interface (UI) of a test tool, services that manage the test, and OSGi services; and an agent bundle relaying message movement with the test case bundle to a framework of a target host.

According to another aspect of the present invention, there is provided a method of testing an OSGi service platform, the method including installing a director bundle, which provides a UI of a test tool, services that manage the test, and OSGi services, in a framework of a test manager host, installing an agent bundle that relays message movement with a test case bundle and a service bundle to be tested, in a framework of a target host, installing a predetermined test case transmitted from the director bundle in the framework of the target host using the agent bundle and performing a test operation, and providing results of the test operation and test logs as a UI or a file.

### BRIEF DESCRIPTION OF THE DRAWINGS

The above aspects of the present invention will become more apparent by describing in detail exemplary embodiments thereof with reference to the attached drawings in which:

FIG. 1 illustrates the entire structure of a test tool for an OSGi service platform provided by a conventional OSGi.org framework;

FIG. 2A illustrates a package diagram of an osgi-refimpl bundle of a conventional OSGi service platform test tool;

FIG. 2B illustrates a package diagram of a target bundle of the conventional OSGi service platform test tool;

FIG. 2C illustrates a package diagram of a director bundle of the conventional OSGi service platform test tool;

FIG. 2D illustrates a package diagram of a support bundle of the conventional OSGi service platform test tool;

FIG. 3 illustrates the entire structure of an OSGi service platform test tool according to an exemplary embodiment of the present invention;

FIG. 4 illustrates a structure of the OSGi service platform test tool in a test manager host according to another exemplary embodiment of the present invention;

FIG. 5 is a diagram of a director bundle according to yet another embodiment of the present invention;

FIG. 6 is a class diagram of com.samsung.miracle.core.test.director which is a kernel package of the director bundle according to yet another exemplary embodiment of the present invention;

FIG. 7 illustrates a structure of the OSGi service platform test tool in a target host according to yet another exemplary embodiment of the present invention;

FIG. 8 is a diagram of an agent bundle according to yet another exemplary embodiment of the present invention;

FIG. 9 is a class diagram of com.samsung.miracle.agentcore.test.target which is a kernel package of the agent bundle according to yet another exemplary embodiment of the present invention;

FIG. 10 is a module diagram of a target host according to yet another exemplary embodiment of the present invention;

FIG. 11 is a module diagram of a test manager host according to yet another exemplary embodiment of the present invention;

FIG. 12 illustrates a detailed module of the agent bundle placed in the target host according to yet another exemplary embodiment of the present invention;

FIG. 13 illustrates a detailed module of the director bundle placed in the test manager host according to yet another exemplary embodiment of the present invention;

FIG. 14 illustrates a method of testing an OSGi service platform according to an exemplary embodiment of the present invention;

FIG. 15 illustrates transition of a state of a bundle;

FIGS. 16A and 16B illustrate a stack structure of a module placed in a test manager host of a conventional OSGi test tool and a stack structure of a module placed in a test manager host of an OSGi test tool according to an exemplary present invention;

FIG. 17 illustrates the method of testing an OSGi service platform by referring to a structure of a test tool according to an exemplary embodiment of the present invention;

FIGS. 18A and 18B illustrate a method of testing an OSGi service platform using a conventional test tool or a test tool according to an exemplary embodiment of the present invention when an OSGi service bundle and test case bundles are developed;

FIG. 19 illustrates a GUI of a test tool based on a director bundle of a test manager host according to another exemplary embodiment of the present invention;

FIG. 20 illustrates a dialog box generated when a button ‘change TC dir’ of box \mathring{5} of FIG. 19 is clicked; and

FIG. 21 illustrates contents of the test summary having an XML format that shows detailed information about test results and logs after the test is performed.

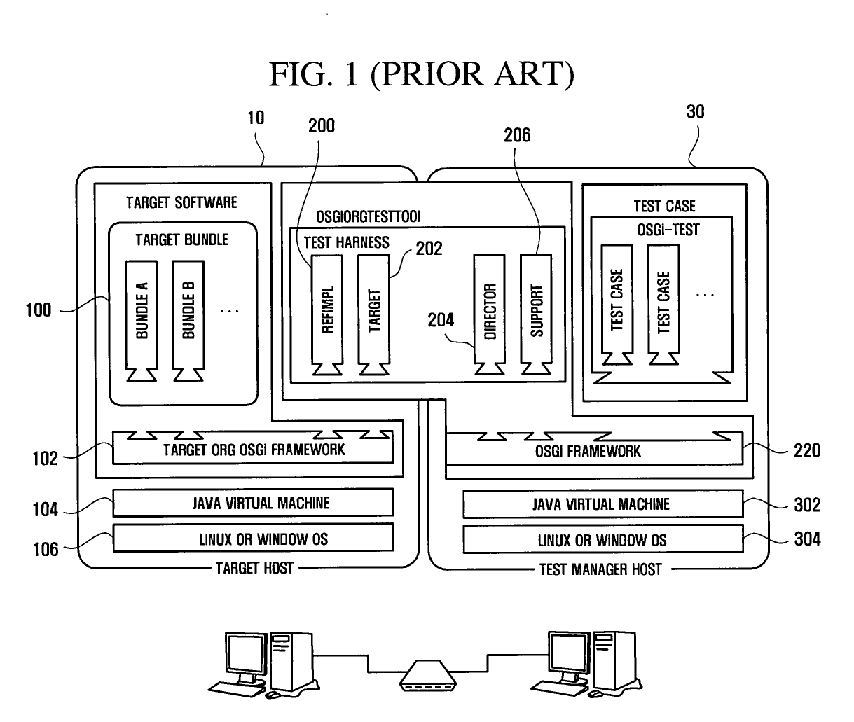

### DETAILED DESCRIPTION OF EXEMPLARY EMBODIMENTS OF THE INVENTION

The present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these exemplary embodiments are provided so that this disclosure will be thorough and complete and will convey the concept of the invention to those skilled in the art, and the present invention will only be defined by the appended claims. Like reference numerals refer to like elements throughout the specification.

Hereinafter, exemplary embodiments of the present invention will be described in detail with reference to the attached drawings.

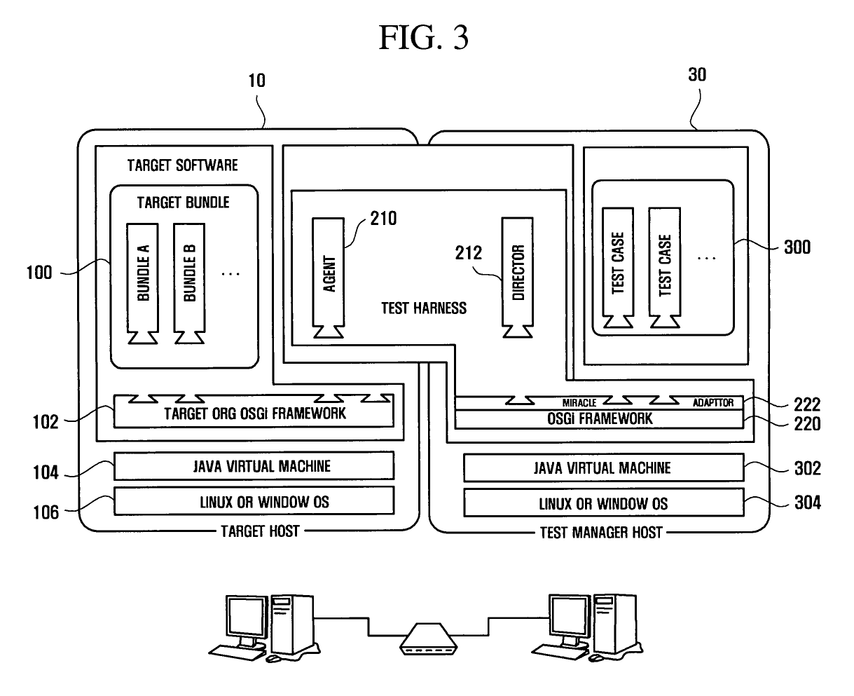

FIG. 3 illustrates the entire structure of an OSGi service platform test tool according to an exemplary embodiment of the present invention.

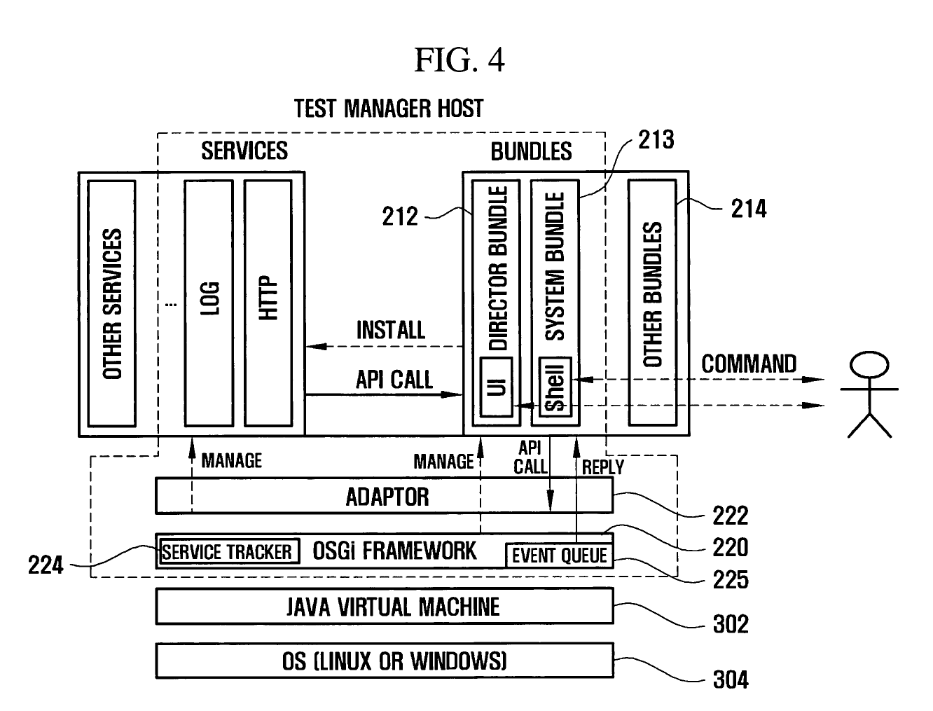

The OSGi service platform test tool placed in a test manager host 30 comprises an OSGi framework 220, an adaptor bundle 222, a system bundle 213, a director bundle 212, and services loaded by the director bundle 212, as shown in FIG. 4. In this case, other bundles 214 that are dynamically loaded on the OSGi framework 220, and a Java virtual machine 302 that provides an environment of the OSGi framework 220, are external components.

Other bundles 214 are dynamically downloaded on the OSGi framework 220, communicate with a framework via an application programming interface (API) call, and communicate with services via the API call and a predetermined interface. In addition, the system bundle 213 provides a shell user interface (UI) that controls the OSGi framework 220 and bundles loaded on the OSGi framework 220, to a tester.

The OSGi framework 220 provides a test execution environment in which test case bundles 300 are loaded and the test is performed.

The adaptor bundle 222 exists in the test manager host 30 and enables the OSGi framework 220 to be used as a framework in the test execution environment.

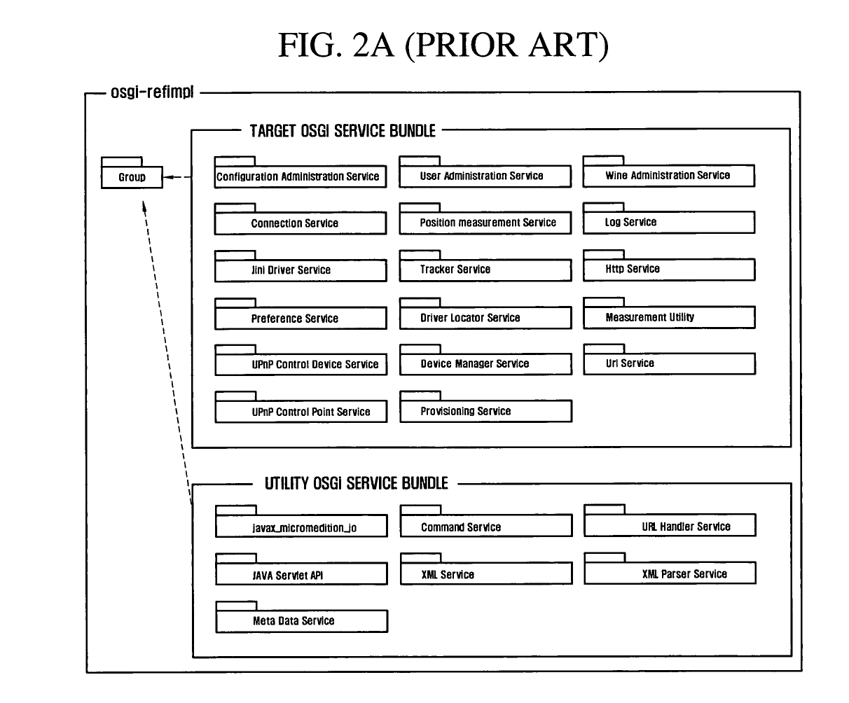

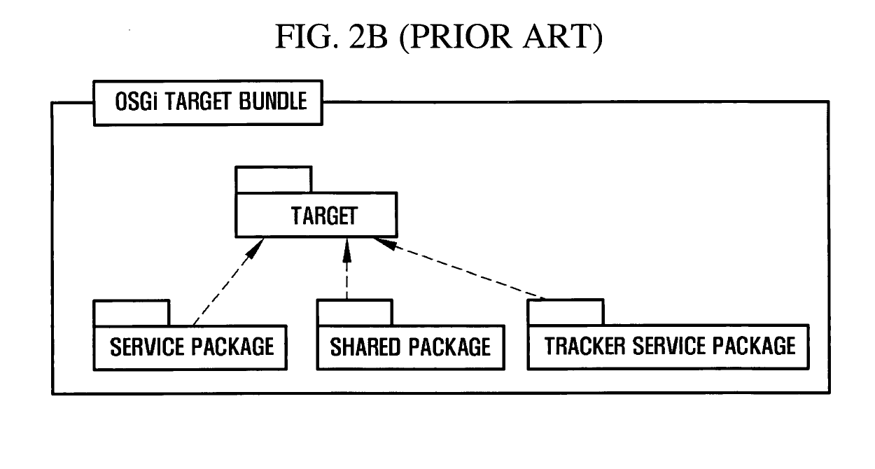

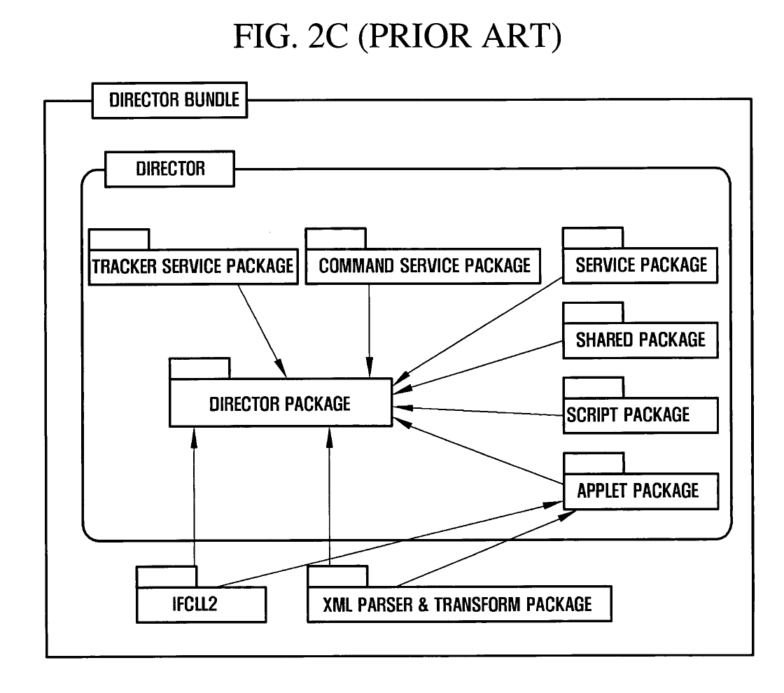

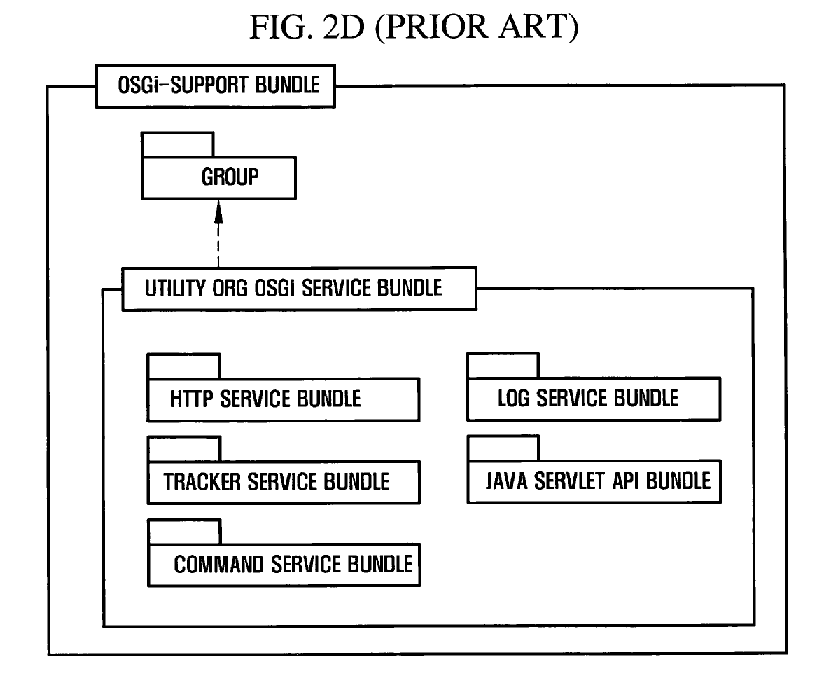

The director bundle 212 provides a UI of a test tool, services that manage the test, and OSGi services needed in the test tool. In this case, the director bundle 212 comprises bundles included in the director bundle and the support bundle shown in FIGS. 2C and 2D, thereby simplifying a structure of the test tool.

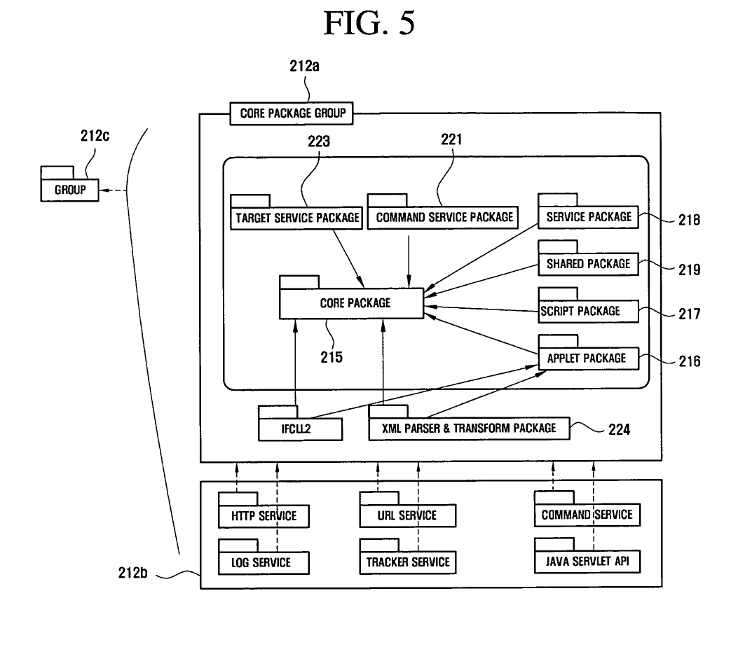

More specifically, the director bundle 212 comprises a core package group 212a, OSGi service bundles 212b, and a group package 212c, as shown in FIG. 5.

The core package group 212a includes a core package 215, an applet package 216, a script package 217, a service package 218, a Shared package 219, a command service package 221, a target service package 223, and an XML Parser & Transform package 224.

The core package 215, a main package of a director package, processes a notification message sent from a target of a target host 10, and manages target registration of the target host 10. In addition, the core package 215 processes a network message sent from the target host 10 and performs a test to process a result. The applet package 216 processes an event of a GUI and user input and transmits them to the director bundle 212. The script package 217 processes a test case written by an extensible markup language (XML) script. The service package 218 provides a utility API, related to processing a network processing module and the test case bundle 300, test log processing, and test performance, to the director bundle 212. The Shared package 219 has an interface of the service package 218. The command service 221 package processes an input from a command line of a console window. The target service package 223 manages a target of the target host 10. The applet package 216 provides a GUI. The XML Parser & Transform package 224 parses and processes an XML.

The OSGi service bundles 212b provide services needed in the core package 215.

The group package 212c installs the core package group 212a and the OSGi service bundles 212b in the OSGi framework 220.

A class diagram of com.samsung.miracle.core.test.director, which is a kernel package of the director bundle 212, will now be described.

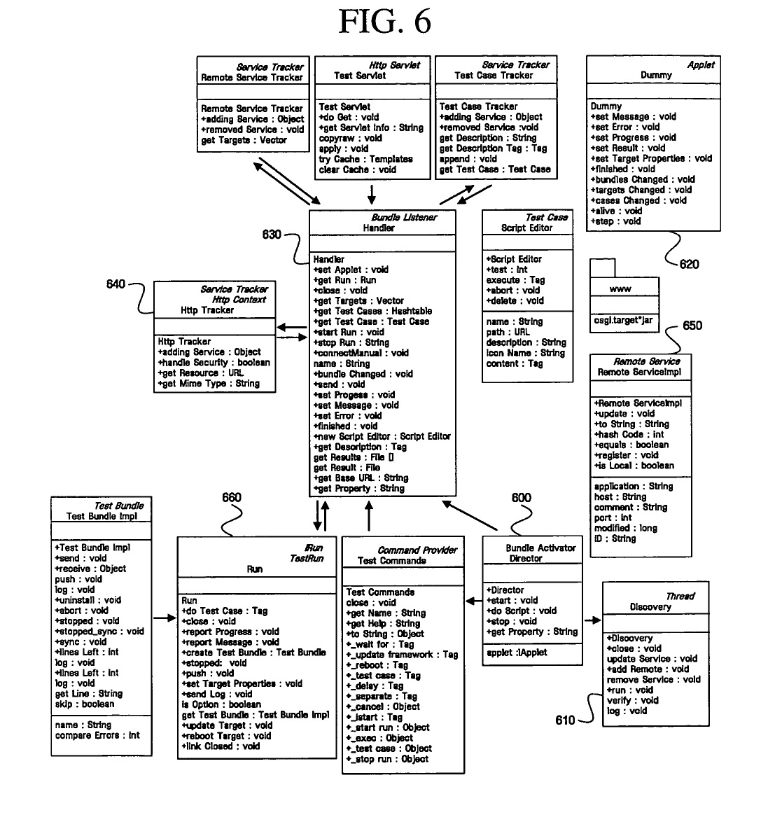

The package includes a director class 600, a discovery class 610, a dummy class 620 of TestApplet, a handler class 630, an HTTP tracker class 640, a RemoteServiceImpl class 650, and a Run class 660, as shown in FIG. 6.

The director class 600 is a BundleActivator of a core bundle placed in the director bundle 212. The discovery class 610 discovers broadcasting information about an agent bundle 210 that operates and that is loaded on a target OSGi framework 102 of the target host 10. The dummy class 620 processes a GUI of a test tool. The handler class 630 serves as a medium of class objects inside a director package. The HTTP tracker class 640 performs tracker services of a service event on a hypertext transfer protocol (HTTP) service. The RemoteServiceImpl class 650 manages information and operation of the agent bundle 210 and the target OSGi framework 102 placed in the target host 10. The Run class 660 performs a test.

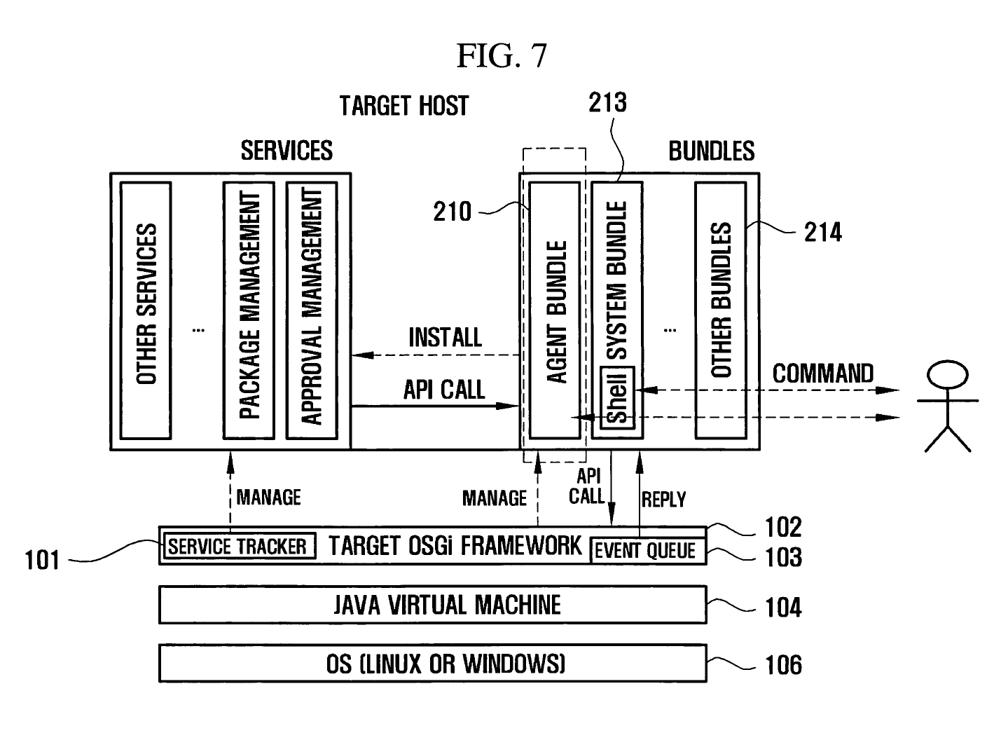

The target host 10 of the OSGi service platform test tool shown in FIG. 3 includes the agent bundle 210, as shown in FIG. 7.

The target OSGi framework 102 and target bundles are external components of the target host 10. The target bundles are dynamically downloaded on the target OSGi framework 102 and communicate with a framework via an API call. In addition, the target bundles communicate with services via the API call and a predetermined interface.

The agent bundle 210 is stacked on the target OSGi framework 102 and serves as a medium for message transmission with the test case bundle 300 between the test manager host 30 and the target OSGi framework 102.

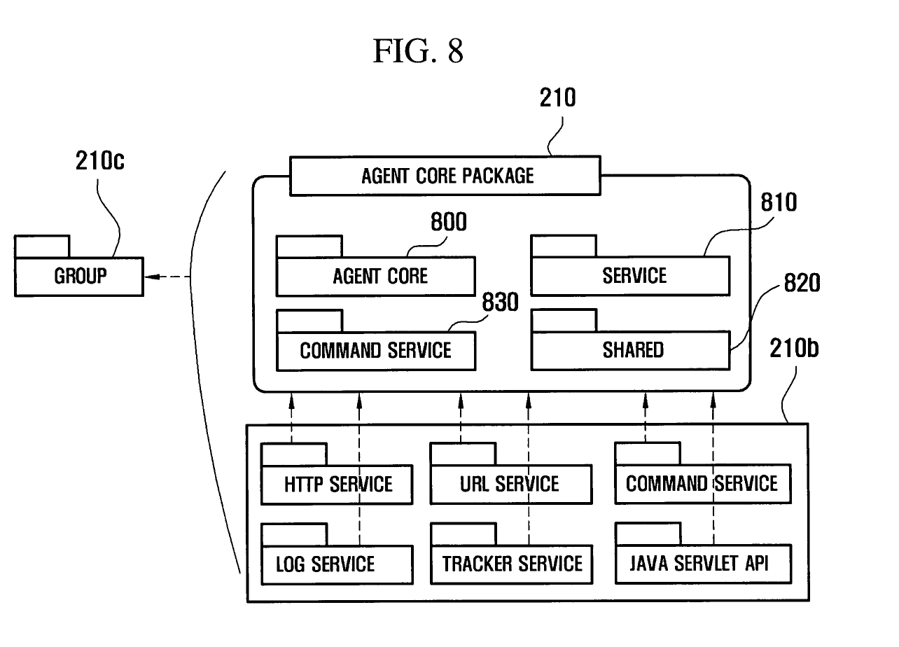

More specifically, the agent bundle 210 comprises an agent core package group 210a, OSGi service bundles 210b that provide services needed in the agent core package group 210a, and a group package 210c that installs the OSGi service bundles 210b in the target OSGi framework 102, as shown in FIG. 8.

The agent core package group 210a includes an agent core package 800, which transmits a notification message that indicates the position of, and information about, the target host 10, is connected to the director bundle 212 placed in the test manager host 30, manages information about the director bundle 212, processes a network message sent from the director bundle 212, and installs the test case bundle 300 transmitted from the director bundle 212 in the target OSGi framework 102 of the target host 10. The agent core package group 210a further includes a service package that provides a utility API, that will process a network processing module and the test case bundle 300, to the agent core package, a Shared package that has an interface of the service package, and a command service 830 that processes a service event that occurred in an OSGi.org framework and informs the agent core service of a processed result, as shown in FIG. 8.

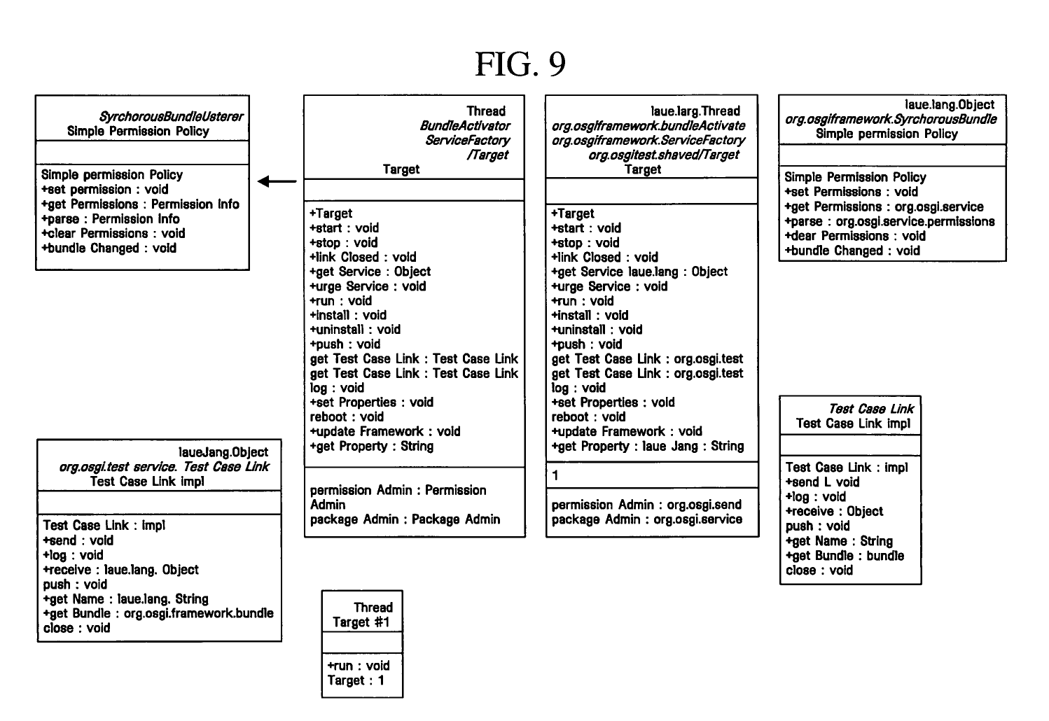

A class diagram of com.samsung.miracle.agentcore.test.target, which is a kernel package of the agent bundle 210, will now be described with reference to FIG. 9.

The package executes a thread that broadcasts at predetermined intervals so as to inform of its own existence and installs the test case bundle 300, transmitted from the director bundle 212 that operates in the test manager host 30, in the target OSGi framework 102. In addition, if the test is completed, the package transmits a test log and a test result to the director bundle 212 placed in the test manager host 30, uninstalls the test case bundle 300 from the target OSGi framework 102, and transmits commands transmitted from the director bundle 212 to the target OSGi framework 102.

A package bundle of the agent bundle 210 comprises bundles included in the osgi-refimpl bundle and the osgi target bundle shown in FIGS. 2A and 2B, thereby simplifying a structure of the test tool. The package bundle of the agent bundle 210 may not comprise the target OSGi services bundle included in the osgi-refimpl bundle. In this case, the target OSGi service bundles needed in the test can be input by a tester through a UI or a script.

Consequently, OSGI service bundles that are not to be tested through the agent bundle 210 need not be installed, thereby saving memory space. For example, only service bundles are actually tested, but when 28 service bundles are included in the refimpl bundle, in a conventional OSGi test tool, all 28 service bundles should be installed at one time. However, according to an exemplary embodiment of the present invention, only 6 service bundles can be independently installed, thereby saving memory space.

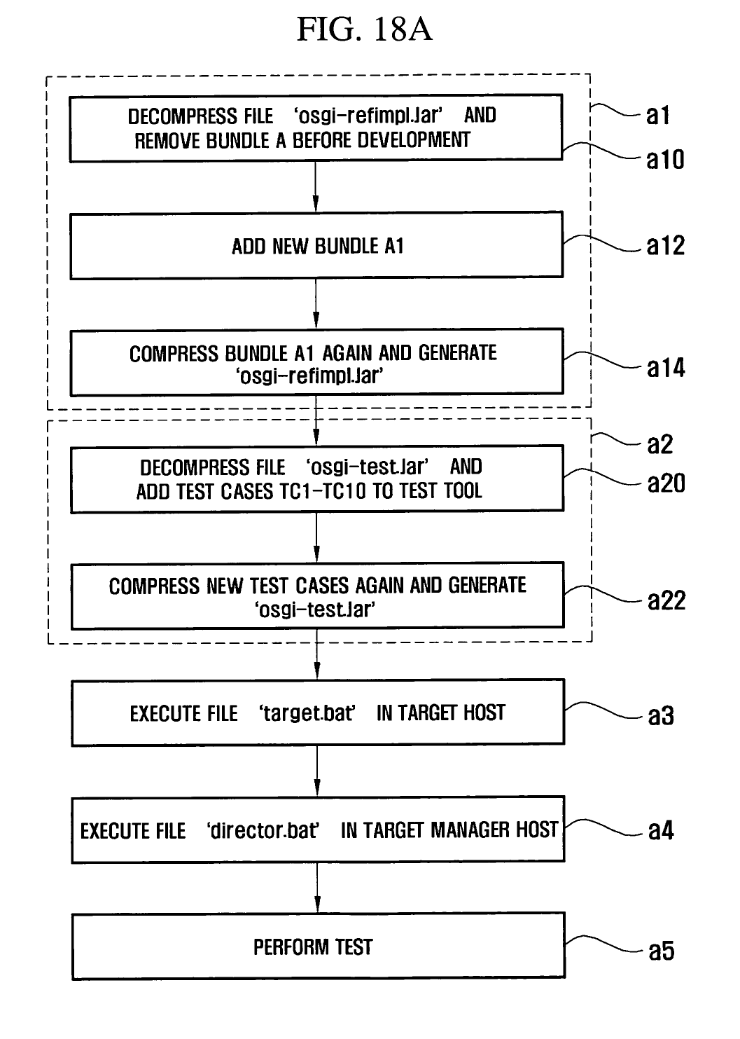

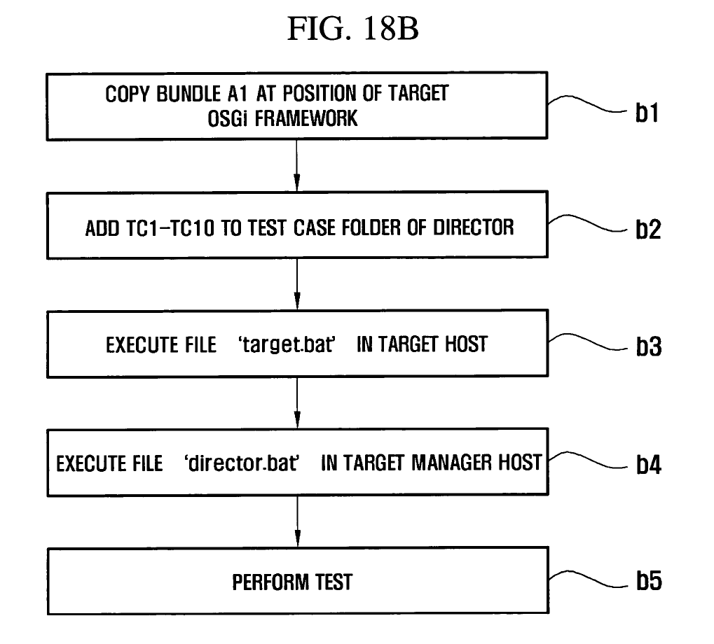

The operation of installing and changing OSGi service bundles according to another exemplary embodiment of the present invention will be described later by comparing the exemplary embodiment with prior art, with reference to FIGS. 18A and 18B.

The test tool divided into module units, which are logical units for performing a test operation, will now be described.

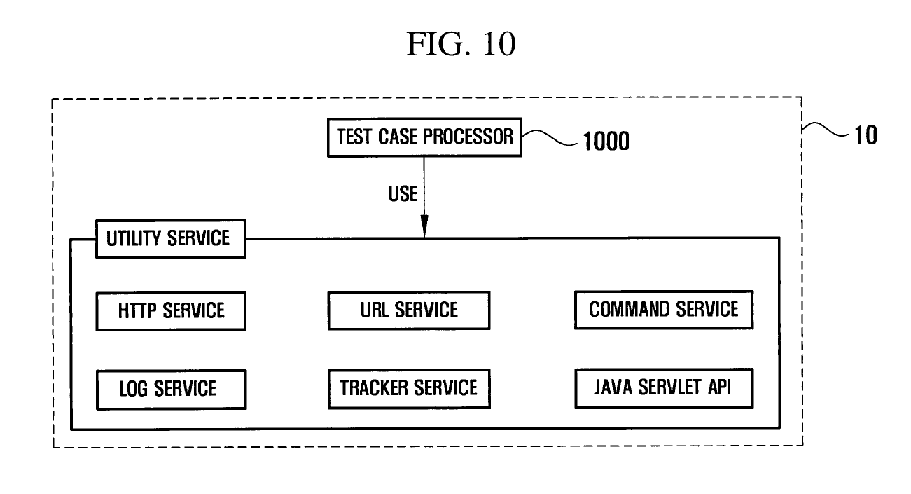

FIG. 10 is a module diagram of the target host 10. The target host 10 comprises a test case processor module 1000 that transmits information about a target to the director bundle 212, installs the test case bundle 300 transmitted from the director bundle 212 during a test operation in the target OSGi.org framework, and transmits logs and a test result to the director bundle 212, and the target host 10 comprises utility service modules needed in a test case processor. Two modules included in the target host 10 constitute one bundle.

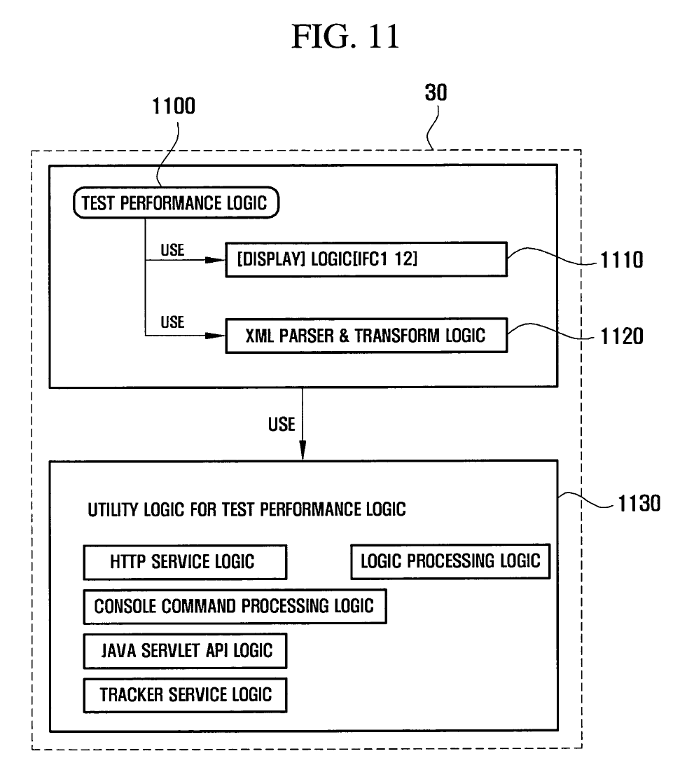

FIG. 11 is a module diagram of the test manager host 30. The test manager host 30 comprises a test performance logic module 1100, a display logic module 1110 for processing a GUI, an XML Parser & Transform logic module 1120 for parsing and processing an XML page, and a utility logic module 1130 needed to test performance logic.

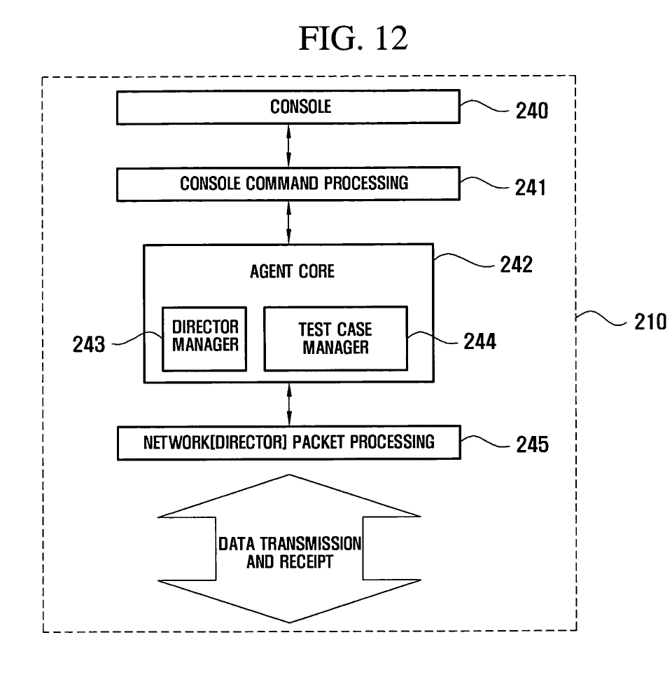

FIG. 12 illustrates a detailed module of the agent bundle 210 placed in the target host 10. The agent bundle 210 comprises an agent core module 242, a network (director) packet processing module 245, a console command processing module 241, and a console module 240.

The agent core module 242 includes a director manager module 243 and a test case manager module 244. The director manager module 243 transmits a notification message that indicates the position of, and information about, the target host 10, serves as an OSGi bundle, and manages the director bundle 212 of the test manager host 30. The test case manager module 244 installs the test case bundle 300 transmitted from the director bundle 212 during a test operation at the target OSGi framework 102, and transmits logs and a test result transmitted from the test case bundle 300 to the director bundle 212.

The network (director) packet processing module 245 processes a packet transmitted from a network and transmits the processed packet to the agent core module 242. The console command processing module 241 outputs logs that occurred during performance of a test case or logs that occurred in the agent core module 242.

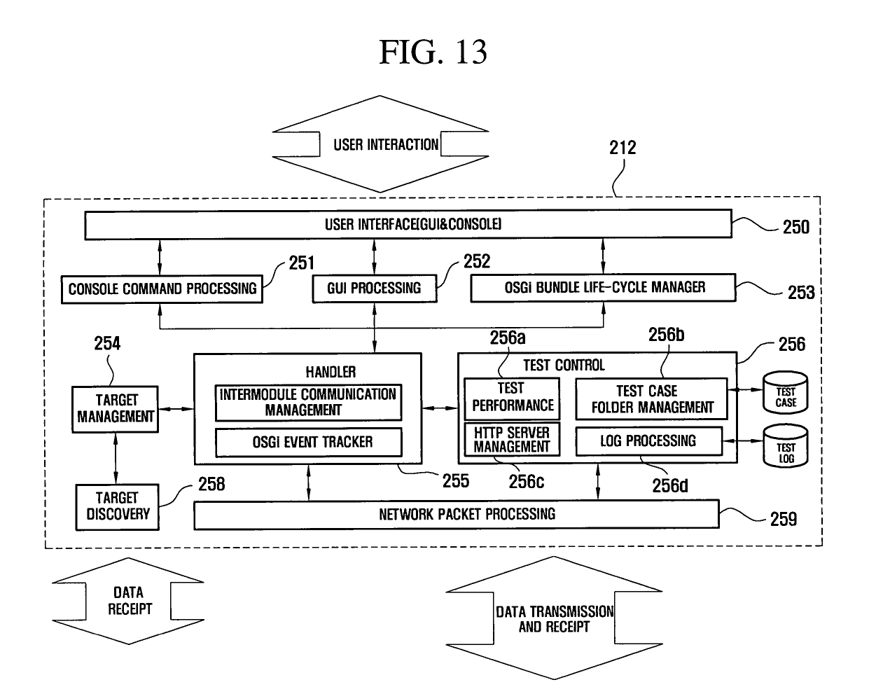

FIG. 13 illustrates a detailed module of the director bundle 212 placed in the test manager host 30.

The director bundle 212 comprises a handler module 255, a test control module 256, a network packet processing module 259, a target discovery module 258, an OSGi bundle life-cycle manager module 253, a GUI processing module 252, and a console command processing module 251.

The handler module 255 includes an intermodule communication manager module that transmits a message between modules placed inside the director bundle 212, and an OSGi event tracker module that detects a service event that occurred in an OSGi framework and transmits the service event to a corresponding module.

The test control module 256 includes a test performance module 256a that manages the entire test performance when the test is performed by request of a tester, a test case folder manager module 256b that manages a folder in which the test case bundles 300 are placed and that installs the test case bundles 300 in the OSGi framework 220 in a desired folder by request of the tester, an HTTP server manager module 256c that manages an HTTP server used by the test case bundles 300, and a log processing module 256d that processes logs transmitted from the agent bundle 210 during a test operation and stores logs output to the GUI of the director bundle 212 in a file having a text format.

The network packet processing module 259 processes a packet transmitted from the agent bundle 210, transmits the processed packet to the handle module 255 and the test control module 256, and processes a packet to be transmitted from the handler module 255 and the test control module 256 to the agent bundle 210.

The target discovery module 258 discovers a notification packet, transmitted from the agent bundle 210 via a broadcast, when the director bundle 212 is executed, if there is information about the detected target host 10, processes, and transmits the information to the target manager module 254.

The OSGi bundle life-cycle manager module 253 provides life-cycle information about a bundle installed in the OSGi framework 220 by request of the tester, changes a state of the bundle, or installs a new bundle in the OSGi framework 220.

The GUI processing module 252 processes the request of a tester through the GUI and transmits the request of the tester to the handler module 255.

The console command processing module 251 processes a command of the tester input through a console window. In this case, a UI that provides a console window and a GUI of a test tool are synchronized with each other so that when an error occurs during a test operation, the state of an OSGi framework or a service bundle can be checked and the cause of the error can be analyzed. For example, a command input unit using a prompt that can deal with an error is implemented to be provided to the console window so that the error that occurred during the test operation can be dealt with and the cause of the error can be analyzed.

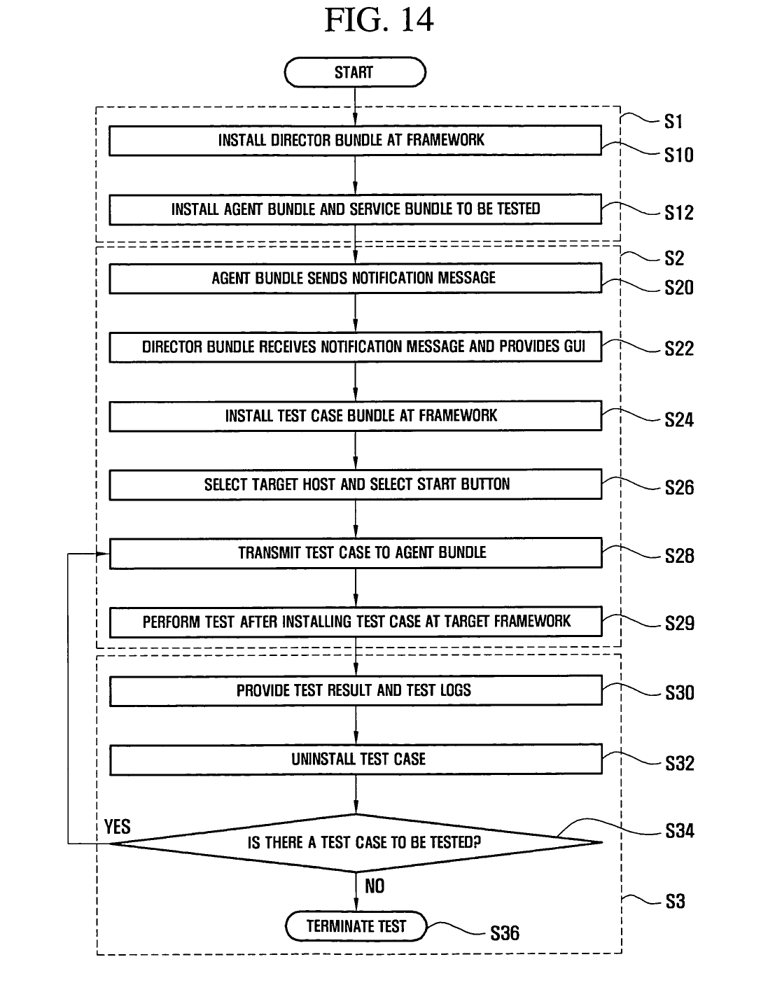

FIG. 14 illustrates a method of testing an OSGi service platform according to an exemplary embodiment of the present invention.

As shown in FIG. 14, the method of testing an OSGi service platform according to an exemplary embodiment of the present invention includes installing a director bundle in a framework placed in a test manager host and installing an agent bundle and a service bundle to be tested in a framework placed in a target host (S1), installing a test case bundle and performing a test operation (S2), and providing a test result and a test log (S3).

Explicit transition of the state of a bundle, which is a functional distribution unit for providing services in the OSGi service platform, will now be described.

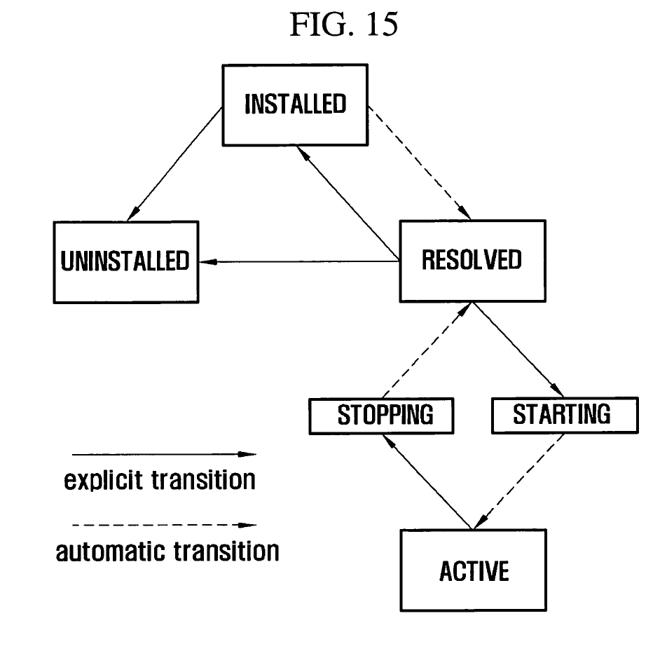

Referring to FIG. 15, a life-cycle of a bundle is explicitly transitioned by an external and defined operational command until the bundle is installed in an OSGi framework and uninstalled therefrom, but if a defined condition is satisfied, the life-cycle of the bundle is automatically transitioned.

The OSGi framework is a kernel component of the OSGi service platform and can dynamically install and update the bundle. The OSGi framework classifies the state of a bundle and manages a life-cycle until the bundle is installed, updated, or reinstalled in the OSGi framework or uninstalled therefrom. In this case, the state of the bundle may be classified as “INSTALLED”, indicating a state where the bundle is successfully installed in the OSGi framework, “RESOLVED”, indicating a state where all Java class files and a native code required by the bundle are installed in an OSGi framework execution environment, “STARTING”, indicating a state where the bundle is being executed, “STOPPING”, indicating a state where the bundle stops, “ACTIVE”, indicating a state where the bundle is being successfully executed and operates, and “UNINSTALLED”, indicating a state where the bundle is removed from the OSGi framework.

The operation S1 of installing the director bundle, the agent bundle, and the service bundles to be tested includes installing the OSGi framework 220 above a Java virtual machine in the test manager host 30, installing the director bundle 212 above the OSGi framework 220 (S10), installing the target OSGi framework above the Java virtual machine in the target host 10, and installing the agent bundle 210 and an OSGi service bundle to be tested above the target OSGi framework (S12).

The OSGi service bundle can be input by the tester through a script or a UI. Specifically, the inputting of the OSGi service bundle through a script may be performed by adding a target test OSGi service bundle to a file ‘osgi.properties’. The case where changes are required due to development of OSGi service bundles needed in the test will be described by comparing an exemplary embodiment of the present invention with prior art, with reference to FIGS. 18A and 18B.

The operation S2 of installing the test case bundle and performing a test operation will now be described in greater detail.

First, if the director bundle 212 sends a GUI of a test tool, the agent bundle 210 sends a notification message that indicates a position of a target host, via a broadcast, in operation S20.

Next, the director bundle 212 analyzes a notification message sent from the agent bundle 210 and displays information about the target host 10 on the GUI of the test tool in operation S22, and the tester installs the test case bundles 300 in the OSGi framework in a folder placed in the test manager host 30 in operation S24, selects the target host 10 to be tested, and clicks a start button of the GUI of the test tool so that a test operation automatically starts in operation S26.

The test case bundles can be input by the tester through a script or a UI. A method of adding a test case bundle to a file, such as a file ‘osgi.properties’ in which test case bundles are collected, may be used to input the test case bundle in the script. In addition, the test case bundles can be input using a command provided by a console window.

The test case bundles according to an exemplary embodiment of the present invention can be independently added without terminating the test operation, even during the test operation and before the test operation. Thus, compared to a conventional method of collectively managing test case bundles in a test case folder, test case bundles can be easily added and implemented.

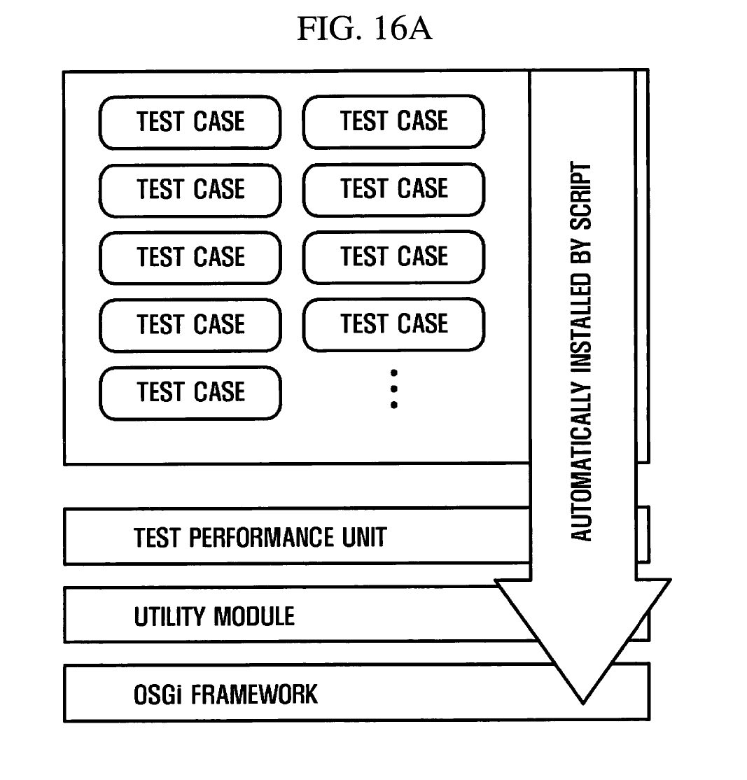

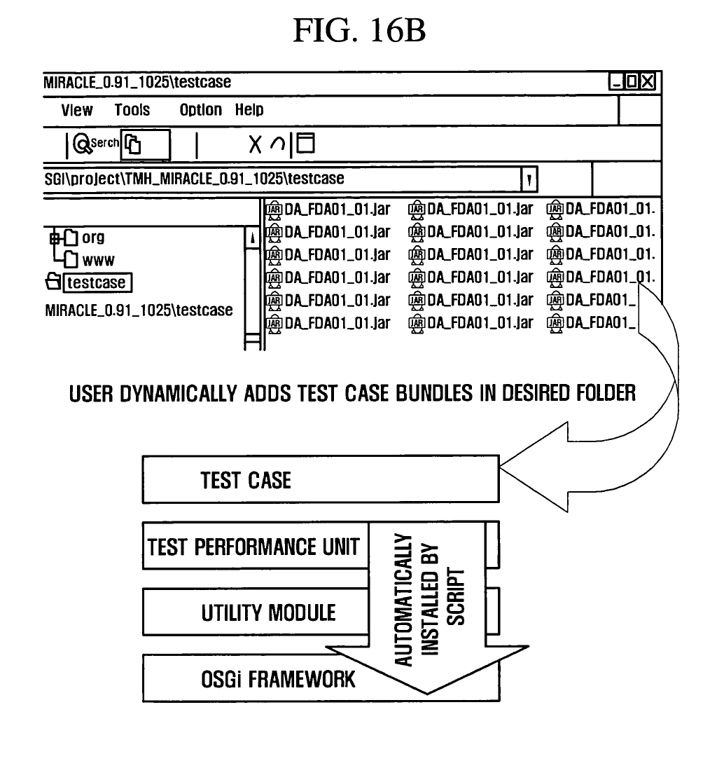

A difference in adding test case bundles between a prior-art test tool and a test tool according to an exemplary embodiment the present invention will be described by comparing a stack structure of modules placed in the test manager host 30 with reference to FIGS. 16A and 16B.

Referring to FIG. 16A, in a prior-art test tool, an OSGi.org framework is automatically executed by an execution batch file, and a utility module that requires an OSGi.org test tool placed in the test manager host 30 is stacked on the OSGi.org framework, a test performance module is executed based on the utility module, and test case bundles are stacked on the OSGi.org framework.

In this case, when test case bundles are added or modified due to development of new test case bundles, a compressed file is decompressed, changes are reflected (contents of a changed file are modified), and a compression operation should be performed again.

Referring to FIG. 16B, in the test tool according to an exemplary embodiment the present invention, the OSGi framework 220 is automatically executed by an execution batch file, and a utility module that requires a test tool placed in the test manager host 30 is stacked on the OSGi framework 220, a test performance module is executed based on the utility module, one or more test case bundles 300 placed in a desired folder are input through a UI, etc., as described previously, and test case bundles are dynamically stacked on the OSGi framework 220.

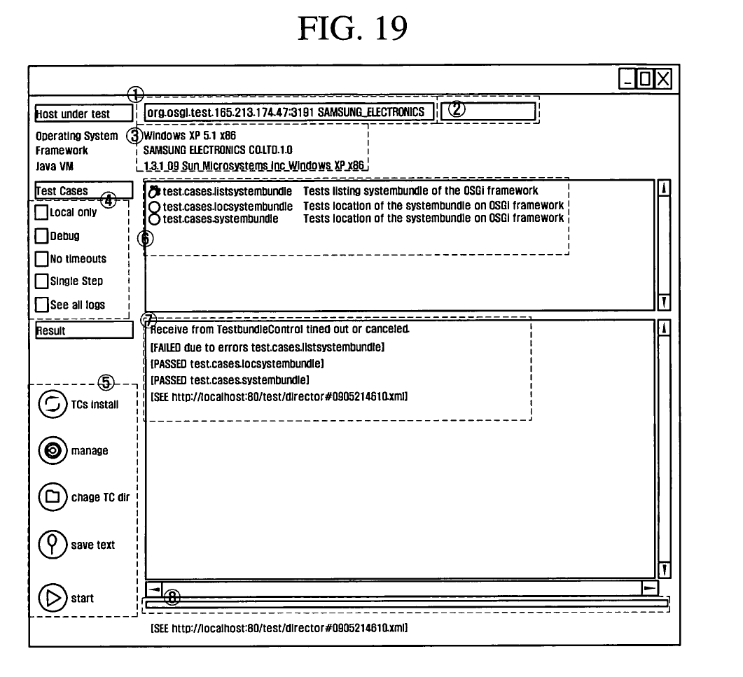

Thus, unlike the conventional OSGi test tool, the test case bundles form a set, are not automatically stacked on the framework and are dynamically installed by the tester. Thus, the test case can be implemented by selecting test case bundles required by the tester to be changed. Here, an operation by which the tester may dynamically select the test case bundles may be performed on a UI screen such as a conversation window and will be described later with reference to FIG. 19. Adding changed or developed test case bundles of the test case will be described later by comparing an exemplary embodiment of the present invention with prior art, with reference to FIGS. 18A and 18B.

Referring to FIG. 14, when the test starts, the director bundle 212 transmits one among the test case bundles 300, selected as the foremost one by the tester to the agent bundle 210 of the target host 10 via a network in operation S28. The agent bundle 210 installs the received test case bundles 300 in the target OSGi framework and performs a test for verifying a specific function of the OSGi service platform in operation S29.

In operation S3 wherein a test result and a test log are output, first, the test case bundles 300 transmit the test result and log to the director bundle 212 placed in the test manager host 30 through the agent bundle 210 and display them on the GUI of the test tool in operations S30. If the test is completed, the agent bundle 210 uninstalls the corresponding test case bundle 300 from the target OSGi framework in operation S32. Next, in operation S34, it is determined whether there is another test case, and if there is another test case, the test is again performed on the corresponding test case, and if there is not another test case, the test is terminated in operation S36.

The test log is provided via the GUI of the test tool on a summary page using an XML after the test is performed on each of the test case bundles 300. In addition, the test log according to an exemplary embodiment of the present invention can be provided in a file having a text format so that the test log can be easily checked even in the case where the test operation is not performed.

In the above-described operation, detailed steps of the operation of installing the director bundle 212 in the OSGi framework 220 placed in the test manager host 30, the operation of operating the installed director bundle 212, the operation of stopping the director bundle 212 as a bundle, and the operation of removing the director bundle 212 from the OSGi framework 220 in the case where the director bundle 212 stops or is installed are disclosed in an OSGi specification (OSGi Service Platform Release 2, October 2001).

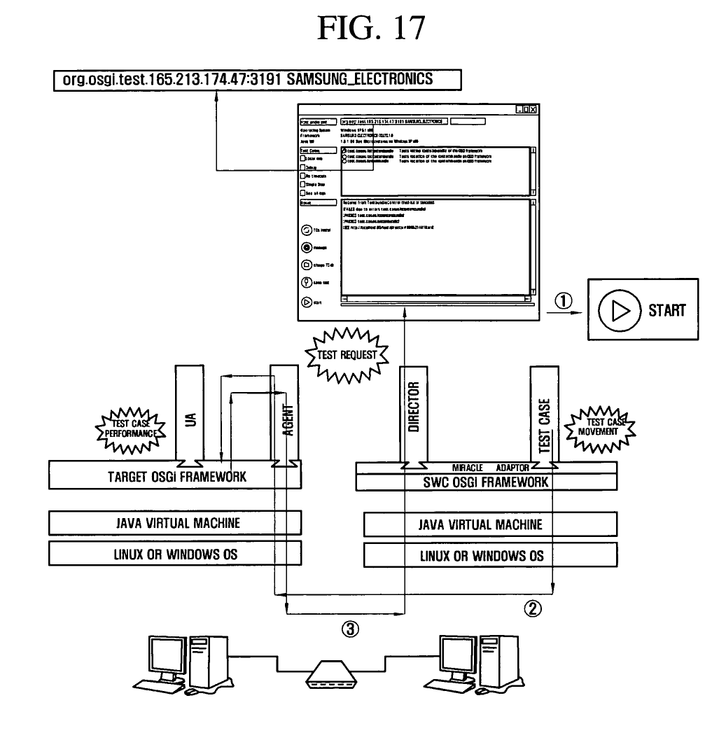

FIG. 17 illustrates the method of testing an OSGi service platform by referring to a structure of a test tool according to an exemplary embodiment of the present invention.

Referring to FIG. 17, when the agent bundle 210 is installed and sends a notification message that indicates an IP address of host and target OSGi frame information, the director bundle 212 installed in the framework detects the message and displays it on the GUI of the test tool. Next, after the tester installs the test case bundles 300 in an SWC OSGi framework 220 and when a start button is clicked through the GUI of the test tool (\mathring{1} of FIG. 17), the test case bundles 300 installed in the OSGi framework are transmitted to the agent bundle 210 via a network, and the transmitted test case bundles 300 are installed in the target OSGi framework and perform the test (\mathring{2} of FIG. 17).

The test result and test log are transmitted by the agent bundle 210 to the director bundle 212 via the network and displayed on the GUI of the test tool, and simultaneously, a more detailed test log is recorded on a test summary page having a text file format \mathring{3} of FIG. 17).

FIG. 18A is a flowchart illustrating a method of testing an OSGi service platform using a conventional test tool when an OSGi service bundle and test cast bundles 300 are developed. FIG. 18B is a flowchart illustrating a method of testing an OSGi service platform using a test tool according to an exemplary embodiment of the present invention when an OSGi service bundle and test case bundles 300 are developed.

Referring to FIG. 18A, when a bundle A1 that is a new OSGi service bundle is added to the test tool, a file ‘osgi-reimpl.jar’ of an osgi-refimpl bundle is decompressed to remove a bundle A before development (a10), the bundle A1 is added to the test tool (a12) and compressed, and a file ‘osgi-reimpl.jar’ is generated (a14).

Referring to FIG. 18B, in the test tool according to an exemplary embodiment of the present invention, a bundle A1 is copied (b1) to a position of a target OSGi framework through a UI or script of the test tool.

In addition, when new test cases TCA1 to TCA10 are added to the test tool, in the conventional test tool shown in FIG. 18A, a file ‘osgi-test.jar’ is decompressed, new test cases TCA1 to TCA10 are added to the test tool (a20), the file is then compressed again, and a file ‘osgi-test.jar’ is generated (a22).

However, in the test tool according to an exemplary embodiment of the present invention shown in FIG. 18B, new test cases TCA1 to TCA10 are added to a test case folder of the director bundle 212 through the UI or the script of the test tool (b2). In this case, since the tester can perform a test operation according to a desired test case bundle at a desired time, the test operation can be controlled according to a test case, unlike in the prior art.

FIG. 19 illustrates a GUI of the test tool based on the director bundle 212 of the test manager host 30 according to an exemplary embodiment of the present invention.

Box \mathring{1} of FIG. 19 shows that the director bundle 212 placed in the test manager host 30 detects information sent from the agent bundle 210 placed in the target host 10 and an IP of the detected agent bundle 210 is displayed. When two or more agent bundles 210 are detected, a combo box is dropped down, and IPs of all agent bundles 210 are displayed. Thus, when two or more agent bundles 210 are detected, the tester drops down the combo box, selects a specific host, and performs a test operation.

Box \mathring{2} of FIG. 19 shows that when there is too much traffic in a network or a load on the network occurs, the director bundle 212 may not detect information sent from the agent bundle 210 so that the tester should input the I P of the host in which the agent bundle 210 exists, to an IP text box of box \mathring{2} thereby performing a test operation.

Box \mathring{3} of FIG. 19 shows information about an operating system (OS) of a system in which the agent bundle 210 detected by the director bundle 212 is loaded, a manufacturer of an OSGi framework, and a Java virtual machine.

Box \mathring{4} of FIG. 19 shows a test option CheckBox enabling the tester to select options when a test operation is performed. The test option CheckBox comprises an option ‘Local only’, which selects only target software of the test manager host 30 in which the director bundle 212 is placed and sets the target software to perform a test operation, an option ‘Debug’, which enables the tester to know the cause of a problem when the problem occurs during the test operation, an option ‘No timeouts’, which sets the target software not to be subjected to a timeout during the test operation, an option ‘Single Step’ which sets the target software to progress whenever the tester requests the test stepwise, and an option ‘See all logs’, which sets the target software to display all logs that occurred during the test operation on a message window of box \mathring{7} of FIG. 19.

Box \mathring{5} of FIG. 19 shows a test menu button which executes a variety of commands related to a test. The test menu button comprises a button ‘TCs install’, which installs (INSTALLED/RESOLVED/STARTING/ACTIVE state transition) a test case in an OSGi framework in a test case folder placed in a lower folder in which an execution file of the test tool exists in the test manager host 30, a button ‘manage’, which executes a dialog box so that the tester can manage (Install/Start/Stop/Unistall/Update) the test case bundles 300 and other bundles, a button ‘change TC dir’, which changes the test case folder into an arbitrary and desired folder to install the test case bundles 300, a button ‘save text’, which stores logs placed on the message window in a text file (.txt format), and a button ‘start’, which executes the test on the test case selected by box \mathring{6} of FIG. 19.

The button ‘change TC dir’ is used to change or add a test case during the test operation, as described previously, and is implemented in such a way that the tester adds a test case to be changed or added through the UI of the test tool to a directory.

Box \mathring{6} of FIG. 19 is a test case list window showing that the test case bundles 300 placed in the test case folder of the test manger host 30 are installed in the OSGi framework 220, by clicking the button ‘TCs install’ of box \mathring{5}. The tester can perform the test by clicking test cases or selecting only a desired test case using a mouse drag. If the tester does not select a test case, all of the test cases are to be tested.

Box \mathring{7} of FIG. 19 is a message window showing logs generated during the test operation and a URL of a Test Summary Page having an XML format.

Box \mathring{8} of FIG. 19 is a Progress bar showing progress information about a test that is in progress.

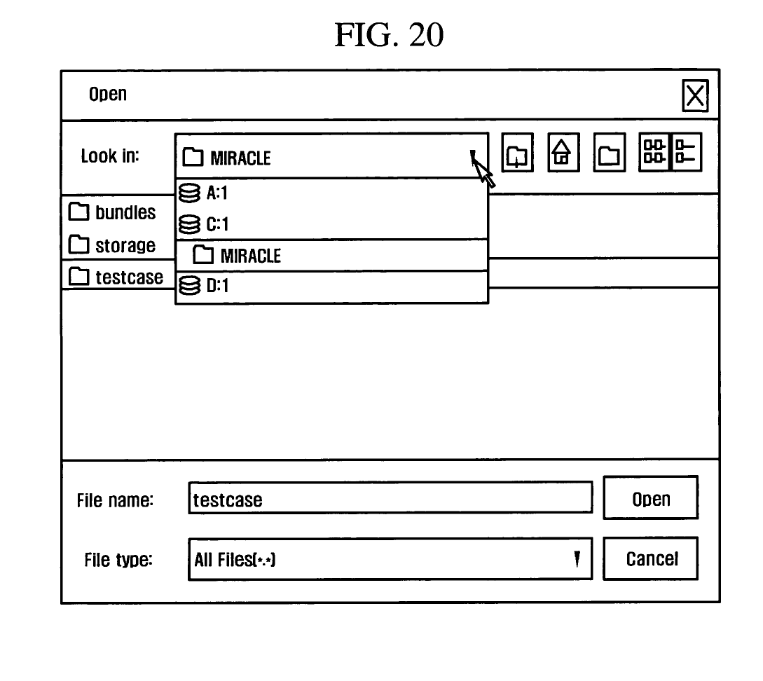

FIG. 20 illustrates a dialog box generated when a button ‘change TC dir’ of box \mathring{5} of FIG. 19 is clicked. Through this dialog box, the tester can select a test case folder that exists in the test manager host 30, as an arbitrary additional folder, and the selected folder is designated as a folder in which the test case bundles 300 are to be placed.

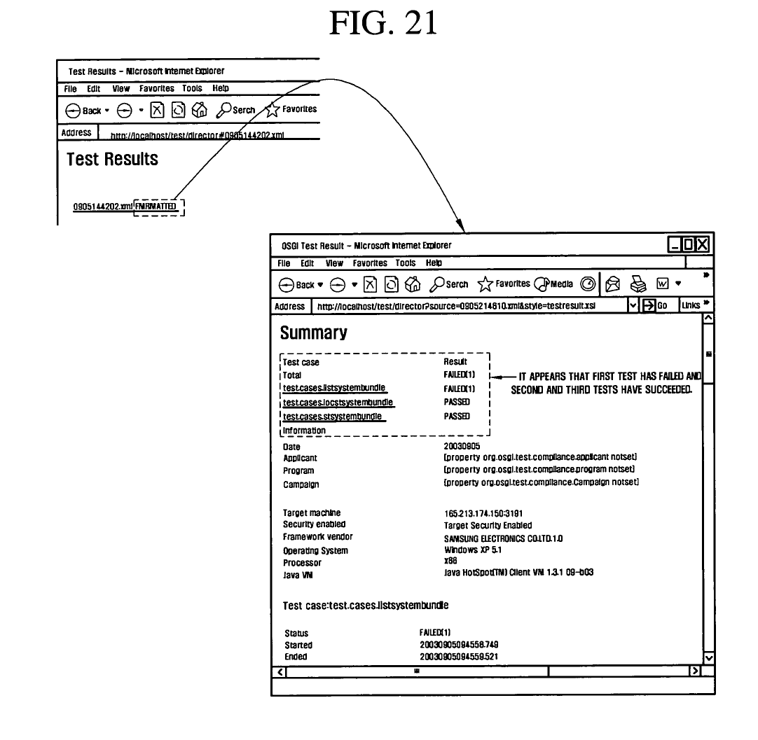

FIG. 21 illustrates contents of a test summary having an XML format that shows detailed information about a test result and logs after the test is performed. Referring to FIG. 21, when the test is completed, if a URL displayed on a message window of box \mathring{7} of FIG. 19 is searched for using an Internet browser such as Internet Explorer or Netscape Navigator, a Test Result web page is loaded as shown in the upper left side of FIG. 21, and if FORMATTED of the web page is clicked, contents of the test summary having the XML format are loaded as shown in the lower right side of FIG. 21. The contents of the test summary include a test pass/fail result of a test case whose execution is completed, logs generated in test performance, and information about a target OSGi framework and the target host 10.

While exemplary embodiments of the present invention has been particularly shown and described with reference to exemplary embodiments thereof, it will be understood by those skilled in the art that various changes in form and details may be made therein without departing from the spirit and scope of the invention as defined by the following claims and equivalents thereof.

As described above, in the method of testing an OSGi service platform and the test tool using the method according to exemplary embodiments of the present invention, first, bundles of OSGi test tools are united with one another so that a structure of the test tool can be simplified.

Second, test cases or OSGi service bundles to be tested can be added or changed conveniently.

Third, when an error occurs in a test operation, the cause of the error can be easily analyzed.

Fourth, test logs are provided as a file having a text format such that the test logs can be easily analyzed at a time when the test operation is not performed.

1. A method of testing an Open Services Gateway Initiative (OSGi) service platform, the method comprising:
installing a director bundle, which provides a user interface (UI) of a test tool, services that manage a test, and OSGi services, in a framework of a test manager host;
installing an agent bundle that relays movement of at least one message and a test case bundle, and a service bundle to be tested, in a framework of a target host;
installing a predetermined test case transmitted from the director bundle in the framework of the target host using the agent bundle and performing a test operation; and
providing results of the test operation and test logs as one of the UI and a file.

2. The method of claim 1, wherein the test case and the service bundle to be installed is input through one of the UI and a script.

3. The method of claim 1, wherein the test logs are provided in a file having a text format.

4. An Open Services Gateway Initiative (OSGi) service platform test tool comprising:
a framework in which at least one test case is installed;
an adaptor which enables the framework to function in a test execution environment;
a director bundle which provides a user interface (UI) of a test tool, services that manage a test, and OSGi services; and
an agent bundle which relays a first message of movement and a test case bundle to a framework of a target host.

5. The OSGi service platform test tool of claim 4, wherein the director bundle comprises:
a handler module which transmits a second at least one message between modules;
a test control module which manages the test case bundle and test logs;
a network packet processing module which transmits a packet between the agent bundle and an internal module;
a target discovery module which discovers information about the target host of the agent bundle;
a target manager module which processes information about the target host;
an OSGi bundle life-cycle manager module which changes a state of a bundle or installs a new bundle in the framework;
a GUI processing module which processes the request of a tester through the GUI and transmits the request of the tester to the handler module; and
a console command processing module that processes a command of the tester input through a console window.

6. The OSGi service platform test tool of claim 5, wherein the agent bundle comprises:
a director manager module which transmits a notification message indicating information about the target host to the director bundle, and manages the director bundle;
a test case control module which installs the test case bundle in the framework and transmits logs transmitted from the test case bundle and a test result to the director module;
a network packet processing module which processes a packet transmitted from a network and transmits the processed packet to the agent bundle; and
a console command processing module which processes test logs.

7. The OSGi service platform test tool of claim 6, wherein the test case and the service bundle to be installed are input through one of the UI and a script.

8. The OSGi service platform test tool of claim 7, wherein the console command processing module of the director bundle includes a unit which inputs a command that relates to an error that occurred during a test operation.

9. The OSGi service platform test tool of claim 8, wherein the test logs are provided in a file having a text format.
